(19) United States
(12) Patent Application Publication
(10) Pub. No.: US 2014/0282064 A1
(43) Pub. Date: Sep. 18, 2014

(54) MULTILAYERED ICON, GRAPHICAL USER INTERFACES, AND METHODS FOR DISPLAYING AND MANIPULATION OF INFORMATION

(71) Applicant: Jeremy Sheldon Miller, Mundelein, IL (US)

(72) Inventor: Jeremy Sheldon Miller, Mundelein, IL (US)

(21) Appl. No.: 14/202,784

(22) Filed: Mar. 10, 2014

Related U.S. Application Data
(60) Provisional application No. 61/777,175, filed on Mar. 12, 2013.

(51) Int. Cl. G06F 3/0481; G06F 3/0484; H04L 29/08; G06F 3/0482

(52) U.S. Cl. CPC G06F 3/04817; G06F 3/0482; G06F 3/04842; H04L 67/306
USPC 715/747

(57) ABSTRACT

A graphical user interface for an electronic device is disclosed. The electronic device has a display, a memory, and one or more processors to execute one or more programs stored in the memory. The graphical user interface displays a multilayered icon on the display of the electronic device. The multilayered icon is displayed at a location on a location screen, the location being a geographical representation of a user of the electronic device. The multilayered icon has a plurality of indicating portions that indicate a plurality of user-selected preferences of the user.

### FIELD OF THE INVENTION

The disclosed embodiments relate generally to programs for electronic devices having graphical user interfaces for displaying data.

### BACKGROUND

Social networking and electronic dating applications have not changed in their basic functions and presentation for several years. Social networking applications typically offer the following functionality: (1) searchable databases containing user-entered identifying characteristics; (2) user profile pages containing user images and identifying characteristics of the user; (3) location arrival notifications; and (4) user-to-user messaging.

Meanwhile, electronic dating applications typically offer the following functionality: (1) searchable databases containing user-entered identifying characteristics; (2) user profile pages containing user images and identifying characteristics of the user; and (4) user-to-user messaging.

The typical social networking and electronic dating applications are inherently limited in their ability to couple real-time electronic communication with the potential for instant face-to-face interaction. For example, a user of a social networking or electronic dating application may initiate a message while the user is in a public setting and engaged in a public activity. The recipient of the message may reply, and the communicating users may arrange for a face-to-face interaction through a series of messages. There is inherent delay in such a system with regard to achieving a face-to-face interaction. Further, even in existing social networking applications, where users may view the location data of another user, the location data is: 1) limited in scope; and 2) limited to location data of a user's pre-defined friends.

The following are several of the major shortcomings in typical social networking and electronic dating applications today: limited ability to interact with users who are not part of a predetermined friend list; limited data available for users that are not a predetermined friend; limited location data; limited, or no, possibility of instant face-to-face interaction; and limited user data on a real-time map.

U.S. Pat. No. 8,223,134, entitled “Portable Electronic Device, Method, And Graphical User Interface For Displaying Electronic Lists and Documents” is incorporated by reference herein in its entirety, as well as the applications referenced therein.

### SUMMARY OF THE INVENTION

The invention relates to computer-implemented methods and graphical user interfaces for displaying, manipulating, and grouping user-data in an application for social networking or dating. The methods and interfaces disclosed herein may be performed by and displayed on any computer, such as a desktop, laptop, PDA, smart phone, and wearable or otherwise transportable computing device. In some embodiments, the computing device has a touch-sensitive display (also known as a “touch screen”) with a graphical user interface, one or more processors, memory and one or more modules, programs or sets of instructions stored in the memory for performing multiple functions.

The invention relates to computer-implemented methods and graphical user interfaces for displaying, manipulating, and grouping user-data in an application for social networking or dating. The methods and interfaces disclosed herein may be performed by and displayed on any computer, such as a desktop, laptop, PDA, smart phone, and wearable or otherwise transportable computing device. In some embodiments, the computing device has a touch-sensitive display (also referred to as a “touch screen”) with a graphical user interface, one or more processors, memory and one or more modules, programs or sets of instructions stored in the memory for performing multiple functions.

In one aspect of the invention, a graphical user interface for an electronic device, the electronic device having a display, a memory, and one or more processors to execute one or more programs stored in the memory, is provided. The graphical user interface comprises a multilayered icon displayed on the display of the electronic device. The multilayered icon is displayed at a location on a location screen, the location being a geographical representation of a user of the electronic device. The multilayered icon has a plurality of indicating portions indicating a plurality of user-selected preferences of the user.

In another aspect of the invention, a multilayered icon is displayed in a graphical user interface of an application being executed on one of the aforementioned computing devices. This multilayered icon addresses the problem of the current state of the art in that there is limited data available to a user of an application who is interested in other users that are previously known or are not a predetermined friend. In a typical social networking program that utilizes a user location display, the visual representation of a user is limited to a single layer of icon, such as a pin point or colored dot. This can lead to the undesirable situation where a first user, who is viewing the location data of a second user being displayed on a map, lacks the requisite information to decide whether to initiate a face-to-face meeting with the second user.

To address this problem, the first aspect of the present invention provides a multilayered icon displayed in a graphical user interface of an application being executed on a computing device. This multilayered icon is further viewable on a location screen that may be a physical map, virtual map, or augmented reality map. The map may be increased or decreased in resolution and scale, and is preferably a size for viewing a single city block or even a single physical establishment, such as a restaurant, bar, or other private or public gathering place. The multilayered icon preferably may represent a plurality of user preferences through a plurality of layers, colors, and/or geometric shapes. Preferably, the multilayered icon is comprised of three layers, with a layer displaying a user's gender, another layer displaying user's sexual preferences, and another layer displaying a user's relationship preferences.

The multilayered icon thus displays on a graphical user interface a first user's preferences to at least a second user of the application. In this manner, the multilayered icon of the first user provides a concise summary of that first user to any second user of the application. Thus the second user of the application, utilizing this graphical user interface with a multilayered icon, will possess the requisite information to decide whether to initiate a face-to-face meeting with the first user.

In another aspect of the invention, a method is provided for manipulating the multilayered icon displayed in the graphical user interface of an application being executed on one of the aforementioned computing devices. This method addresses the problem of the current state of the art in that there is no manner in which to alter, in real-time, a user's location icon, that is viewable on a location screen. In a typical social networking program that utilizes a user location screen, a user's location icon is limited to a single layer of icon, such as a pin point or colored dot. This icon is further limited in that it that displays static information about the user. This lack of flexibility can lead to the undesirable situation where a user of the application, who is transmitting location data to other users via a location screen, lacks the ability to transmit dynamic information about changed preferences to the other users of the application.

To address this problem, another aspect of the present invention provides a method for dynamically selecting user information to be displayed as a multilayered icon and dynamically displaying an updated multilayered icon. As previously discussed, the multilayered icon is viewable on a location screen that may be a physical map, a virtual map, or an augmented reality map. The method comprises a step of presenting a user with a plurality of user preferences that correspond to preferences that can be displayed as layers of a multilayered icon. For example, the user may be presented with a choice of gender options, a sexual preference options, and a relationship preference options. The method comprises a step of accepting a user selection of at least one of a plurality of user preferences. The step of accepting the user selection may be accomplished by any interface means, such as touch screen, keyboard, mouse, eye-tracking indication, or verbal input. The method further comprises a step of storing the user selection in computer memory. Another step of the method is updating the multilayered icon with the user selection. An additional step to the method may involve displaying the user selection in a highlighted manner until a user makes a new, mutually exclusive selection, or de-selects a previous selection.

In this manner, the method of this aspect of the invention allows for dynamic manipulation of the multilayered icon as a user's real-time interests change.

In yet another aspect of the invention, another method is provided for manipulating the multilayered icon displayed on one of the aforementioned computing devices. This method addresses the problem of the current state of the art in that there is no manner in which to view, manipulate, and group, in real-time, data related to a user's location icon being viewed on a location screen. In a typical social networking program that utilizes a user location display, a user's location icon is limited to a single layer of icon, such as a pin point or colored dot, that displays static information which is further not able to be manipulated on the location display. This can lead to the undesirable situation where a first user of an application, who is viewing the location icon of a second user on a map, lacks the ability to view characteristics of that second user and then manipulate the information related to the second user.

To address this problem, another aspect of the present invention provides a method of displaying a first user's multilayered icon, allowing a second user to view the characteristics of a first user by interacting with the multilayered icon, and further allowing the second user to manipulate and group those characteristics. As previously discussed, the multilayered icon is viewable on a location. The method comprises the step of displaying a multilayered icon of a first user. The method further comprises a step of accepting a selection of the multilayered icon by a second user. The step of accepting the second user's selection may be accomplished by any interface means, such as receiving an input through touch screen, keyboard, mouse, eye-tracking indication, or verbal input. The method comprises another step of storing the second user's selection. The method further comprises the step of displaying at least one stored characteristic of the first user in response to the selection. This stored characteristic of the first user is preferably an image of the first user, but may be any data such as age, distance, etc. The image of the first user is further preferably an image associated with a profile screen of the first user. The method comprises another step of accepting a manipulating input by the second user. This manipulating input is preferably in the form of a finger touch to a touch screen display and subsequent drag of the stored characteristic toward a designated area. However, in other applications, audible commands, eye-tracking, mouse gesturing, or other physical inputs may alternatively be used as the means for the manipulating input. The method comprises another step of retaining the manipulated stored characteristic in the designated area. In the preferred embodiment, the designated area is a peripheral panel where the stored characteristic is an image and the designated area may retain the images of multiple users whose characteristics have been dragged into the designated area.

An additional step to the method discussed above may involve accepting a second manipulating input from the second user to remove a stored characteristic from the designated area. The second manipulating input may be of any form previously discussed first manipulating input. In the preferred embodiment, this second manipulating input is in the form of a finger touch to a touch screen display and subsequent drag of the stored characteristic away from the designated area.

A further optional step to the method discussed above may involve accepting a second selection from the second user of at least one stored characteristic retained in the designated area. The application then highlights the stored characteristic in response to the second selection. The application further includes the step of presenting a communication icon. Selection of the communication icon by the second user enables a communication to be transmitted from the second user to any other user associated with the highlighted characteristic.

In this manner, the method of this aspect of the present invention allows for dynamic presentation of a stored user characteristic, associated to a multilayered icon, and subsequent manipulation of the stored user characteristic.

### BRIEF DESCRIPTION OF THE DRAWINGS

FIG. 1 illustrates a user interface for displaying an access screen for an application on an electronic device in accordance with some embodiments;

FIG. 2 illustrates a first user interface for creating a multilayered icon in accordance with some embodiments;

FIG. 3 illustrates a second user interface for creating a multilayered icon in accordance with some embodiments;

FIG. 4 illustrates a third user interface for creating a multilayered icon in accordance with some embodiments;

FIG. 5 illustrates a fourth user interface for creating a multilayered icon in accordance with some embodiments;

FIG. 6 illustrates a user interface for creating a user identity in accordance with some embodiments;

FIG. 7 illustrates a user interface for assigning a user photograph in accordance with some embodiments;

FIG. 8 illustrates a user interface for creating a user profile in accordance with some embodiments;

FIG. 9 illustrates another user interface for creating a user profile in accordance with some embodiments;

FIG. 10 illustrates a tutorial screen in accordance with some embodiments;

FIG. 11 illustrates a messaging screen in accordance with some embodiments;

FIG. 12 illustrates a location screen in accordance with some embodiments;

FIG. 13 illustrates a first profile screen in accordance with some embodiments;

FIG. 14 illustrates a second profile screen in accordance with some embodiments;

FIG. 15 illustrates a home screen in accordance with some embodiments;

FIG. 16 illustrates a message board screen in accordance with some embodiments;

FIG. 17 illustrates a search screen in accordance with some embodiments;

FIG. 18 illustrates an entry screen in accordance with some embodiments;

FIG. 19 illustrates a method of displaying a multilayered icon in accordance with some embodiments;

FIG. 20 illustrates a method of displaying user information in a designated area in accordance with some embodiments;

FIG. 21 illustrates a message screen in accordance with some embodiments;

FIG. 22 illustrates another location screen in accordance with some embodiments;

FIG. 23 illustrates a home screen of a user in accordance with some embodiments;

FIG. 24 illustrates another location screen in accordance with some embodiments;

FIG. 25 illustrates another messaging screen in accordance with some embodiments;

FIG. 26 illustrates another search screen in accordance with some embodiments;

FIG. 27 illustrates another creation screen for a multilayered icon in accordance with some embodiments;

FIG. 28 illustrates another location screen in accordance with some embodiments;

FIG. 29 illustrates another profile screen in accordance with some embodiments;

FIG. 30 illustrates another profile screen in accordance with some embodiments; and

FIG. 31 illustrates another home screen in accordance with some embodiments.

### DETAILED DESCRIPTION OF THE PREFERRED EMBODIMENT

Referring to FIGS. 2-5, exemplary tutorial screens 100, 110, 120, and 130 for guiding a user to create a multilayered icon is provided. The components of the multilayered icon are displayed on a graphical user interface of an application being executed by a computer, such as a desktop, laptop, PDA, smart phone, and wearable or otherwise transportable computing device. Preferably, the application is a social networking or electronic dating application on a transportable computing device. An example of a preferred embodiment of the multilayered icon 102 is illustrated in FIG. 5. The multilayered icon 102 is representative of at least one user of the application. This multilayered icon 102 is further viewable on a location screen (e.g., 104 in FIG. 12, 106 in FIG. 22) that may be a physical map, virtual map, or augmented reality. The map may be increased or decreased in resolution and scale, and is preferably a size for viewing a single city block or even a single physical establishment such as a dwelling, bar, restaurant, etc.

The multilayered icon 102 preferably may represent a plurality of user characteristics through a plurality of layers, colors, and/or geometric shapes. Preferably, the multilayered icon 102 is comprised of three layers or indicating portions, with one gender component 108 graphically displaying a user's gender (as shown in FIG. 2), a sexual preference portion 112 graphically displaying a user's sexual preference (as shown in FIG. 3), and a relationship preference portion 114 graphically displaying a user's relationship preference portion (as shown in FIG. 4). The application displaying the multilayered icon 102 accepts user selections relating to the each portion and thus compiles or displays the multilayered icon 102 accordingly. The multilayered icon 102 thus displays, in a graphical user interface, a first user's characteristics to at least a second user of the application. In this manner, the multilayered icon 102 of a user provides a concise summary of that user to any other users of the application.

It will be apparent to one of ordinary skill in the art that the illustrated embodiments of the multilayered icon need not be limited to a particular color, geometric shape, number of layers, or particular layering order or arrangement. The multilayered icon need not be composed of discrete “layers” when displayed in the graphical user interface, per se, and may in turn be composed of discrete portion residing in the displayed layer, such as portions of a single image file or multiple image files, in the graphical user interface so as to form a composite icon.

A first method 200 for manipulating the multilayered icon displayed on a graphical user interface of an application being executed by a computer, such as a desktop, laptop, PDA, smart phone, and wearable or otherwise transportable computing device is illustrated in FIG. 19. The computing device may include a processor coupled, computer memory, a memory controller, RF circuitry, and a display as mentioned above. The method comprises a step of displaying a plurality of user preferences 202 that correspond to preferences that can be displayed as layers of a multilayered icon. For example, the user may be presented with a choice of gender options, a sexual preference options, and a relationship preference options. The method comprises a step of accepting a user selection 204 of at least one of a plurality of user preferences. The step of accepting the user selection may be accomplished by any interface means, such as touch screen, keyboard, mouse, eye-tracking indication, or verbal input. The method further comprises a step of storing the user selection 206 in computer memory of the computer executing the application. Another step of the method is updating the multilayered icon 208 with the user selection. The step of updating the multilayered icon is performed by the processor of the computer and is preferably transmitted to a centralized server that in turn transmits the updated icon information to other users executing the application. An additional step to the method may involve displaying the user selection in a highlighted manner 210 until a user makes a new, mutually exclusive selection, or de-selects a previous selection 212, and further removing the highlight 214 associated with the first user selection.

Another method 240, illustrated by way of flow diagram in FIG. 20, allows for manipulation of the multilayered icon displayed on one of the aforementioned computing devices. This method of displays a first user's multilayered icon, allowing a second user to view the characteristics of a first user by interacting with the multilayered icon, and further allows the second user to manipulate and group those characteristics. The method comprises the step of displaying a multilayered icon 242 of a first user. The method further comprises a step of accepting a selection of the multilayered icon 244 by a second user. The step of accepting the second user's selection may be accomplished by any interface means, such as receiving an input through touch screen, keyboard, mouse, eye-tracking indication, or verbal input. The method comprises another step of storing the second user's selection 246. The method further comprises the step of displaying at least one stored characteristic of the first user in response to the selection 248. This stored characteristic of the first user is preferably an image 250 of the first user, as illustrated, for example, in FIGS. 12, 22, and 24 but could be any data related to the first user, such as location, age, etc. The image 250 of the first user is further preferably an image associated with a profile overview screen 252 illustrated, for example, in FIGS. 15 and 29, or a second or full profile screen 254 illustrated in FIG. 14) of the first user. The method comprises another step of accepting a manipulating input 256 by the second user. This manipulating input is preferably in the form of a finger touch to a touch screen display and subsequent drag 258 of the stored characteristic toward a designated area as illustrated in FIG. 12. However, in other applications, audible commands, eye-tracking, mouse gesturing, or other physical inputs used to manipulate the displayed stored characteristic may alternatively be used for the manipulating input. The method comprises another step of retaining the manipulated stored characteristic 260 in a designation area. In the embodiments illustrated in FIGS. 12, 22, and 24, the designation area is a peripheral panel 262 where the stored characteristic is an image of the first user and the designation area may retain the images of multiple users associated to other stored characteristics.

Referring to FIG. 20, an additional step to the method 240 discussed above may involve accepting a second manipulating input 264 from the second user to remove a stored characteristic from the designation area. The second manipulating input 264 may be of any form previously discussed first manipulating input 256. In the preferred embodiment, this second manipulating input 264 is in the form of a finger touch to a touch screen display and subsequent drag of the stored characteristic away from the designation area.

A further optional step to the method 240 discussed above may involve accepting a second selection 266 from the second user of at least one stored characteristic retained in the designated area. The application then highlights the stored characteristic 268 in response to the second selection. The application further includes the step of presenting a communication icon 270. Selection of the communication icon by the second user 272 enables a communication to be transmitted 274 to any user associated with the highlighted characteristic.

Referring now to FIGS. 13 and 14, a user may have a limited or first profile 300 and an expanded or second profile 310. Access to the second profile 310 may be controlled via an invite key icon 314 that allows a first user to enable a second user to view the first user's profile. The invite key 314 is a means, which may be represented by any graphical icon, to allow a third party to view a user's profile without requiring that the user designate the third party as a trusted party or friend. An additional feature is illustrated in FIGS. 13 and 14, which is the rating indicator 318 for users of the application disclosed in FIGS. 1-31. The rating indicator 318 incorporates a plurality of flags that serve as warnings for users of the application. A flag may be applied by a user of the system in the limited profile screen 300 or full profile screen 310.

Referring to FIGS. 12, 17, and 26, the application disclosed herein preferably integrates a traditional searchable profile database with a location display data via a variety of displayed filtering icons 320 and fields 324. Searchable criteria or data preferably includes, but is not limited to, the age, sex, sexual preference, and group or Shynite 330 preference. The Shynite 330 preference is an invitation to join a group of two or more users. Thus a Shynite 330 of two represents two users joined, and consequently searchable, as a group. The Shynite 330 may appear as a plurality of multilayered icons in a group (FIG. 28).

Referring to FIG. 14, the application disclosed herein preferably allows a user to follow a particular post or message of another user via a follow or subscribe link 340. When a message has been subscribed to by a user, the message will be retained in a tab area 350 (FIG. 29). The user may receive notifications that the subscribed to message has been updated or has received comments from other users. A user may additionally subscribe to photographs and videos posted by any other user.

The foregoing disclosure of specific embodiments is intended to be illustrative of the broad concepts comprehended by the invention.

1. A graphical user interface for an electronic device, the electronic device having a display, a memory, and one or more processors to execute one or more programs stored in the memory, the graphical user interface comprising:
a multilayered icon, the multilayered icon displayed on the display of the electronic device, the multilayered icon displayed at a location on a location screen, the location being a geographical representation of a user of the electronic device, and the multilayered icon having a plurality of indicating portions, the indicating portions indicating a plurality of user-selected preferences of the user.

2. The graphical user interface of claim 1, wherein the indicating portions are selected from at least one of a plurality of colors and a plurality of geometric shapes.

3. The graphical user interface of claim 1, wherein the indicating portions indicate at least one of a sexual preference, a sex, and a relationship status of the user.

4. The graphical user interface of claim 1, further comprising a second multilayered icon, the second multilayered icon displayed at a location on the location screen, the location being a geographical representation of a second user of a second electronic device, and the second multilayered icon having a plurality of indicating portions, the indicating portions indicating a plurality of user-selected preferences of the second user.

5. The graphical user interface of claim 1, wherein
in response to detecting an input from the user into the electronic device, the input being a change to at least one of the plurality of user-selected preferences,
the indicating portions of the multilayered icon are updated to indicate the change to the at least one of the plurality of user-selected preferences.

6. The graphical user interface of claim 1, wherein the multilayered icon is displayed at a location on a location screen with at least one other multilayered icon in a group.

7. A graphical user interface for an electronic device, the electronic device having a display, a memory, and one or more processors to execute one or more programs stored in the memory, the graphical user interface comprising:
a location screen displayed on the electronic device of a first user;
a multilayered icon, the multilayered icon displayed at a location on the location screen, the location being a geographical representation of a second user, the multilayered icon having a plurality of indicating portions, the indicating portions indicating a plurality of user-selected preferences of the second user;
a designation area;
wherein:
in response to detecting a selecting input from the first user, the selecting input indicating a selection of the multilayered icon of the second user, at least one characteristic of the second user is displayed.

8. The graphical user interface of claim 7, wherein:
in response to detecting a manipulating input from the first user, the at least one characteristic of the second user is displayed in the designation area.

9. The graphical user interface of claim 8, wherein the designation area is displayed on the periphery of the location screen and is sized to retain the at least one characteristic of a plurality of users.

10. The graphical user interface of claim 7, wherein the at least one characteristic of the second user is a photograph provided by the second user.

11. The graphical user interface of claim 7 wherein:
in response to the second selecting input by the first user, displaying a communication icon, the communication icon enabling a message to be transmitted to the second user.

12. The graphical user interface of claim 11 wherein the communication icon enables a message to be transmitted to a plurality of users.

13. The graphical user interface of claim 7 wherein the least one characteristic includes a link to a limited profile of the second user.

14. The graphical user interface of claim 7 wherein the least one characteristic includes a link to a full profile of the second user.

15. The graphical user interface of claim 7 wherein the least one characteristic includes a rating indication of the second user.

16. The graphical user interface of claim 7 wherein the rating indication is one of a plurality of flags.

17. A graphical user interface for an electronic device, the electronic device having a display, a memory, and one or more processors to execute one or more programs stored in the memory, the graphical user interface comprising:
a profile screen displayed on the electronic device of a first user;
a tab area displayed on the profile screen; and
wherein:
when a tab is subscribed to by the first user, the tab is retained in the tab area, and the first user receives a notification when the tab has updated.
